(19) United States
(12) Patent Application Publication
(10) Pub. No.: US 2014/0278847 A1
(43) Pub. Date: Sep. 18, 2014

(54) SYSTEMS AND METHODS FOR VIRTUALIZED ADVERTISING

(71) Applicant: Fabio Gallo, Arzier (CH)

(72) Inventor: Fabio Gallo, Arzier (CH)

(21) Appl. No.: 13/804,788

(22) Filed: Mar. 14, 2013

(51) Int. Cl. G06Q 30/02

(52) U.S. Cl. CPC G06Q 30/0252
USPC 705/14.5

(57) ABSTRACT

The present application is directed to systems and methods for providing virtualized advertising in a simulated view of a real event. A virtualization engine may generate a virtual environment modeled on a real world environment in which the event occurs. Virtual advertisement placement locations may be identified in the virtual environment as corresponding to a physical location in the real environment, such as a billboard, raceway signage, sky writing, vehicle livery advertisements, or other such locations and virtual advertisements may be dynamically changed, may be animated or moving, or otherwise may be modified based on a user profile or motion of a virtual camera within the virtual environment.

### FIELD OF THE INVENTION

The methods and systems described herein relate generally to advertising in a virtual environment simulating a real event. In particular, the methods and systems described herein relate to providing virtualized advertising in a simulated view of a real event to replace physical advertisements in the real event.

### BACKGROUND OF THE INVENTION

Many events, such as sporting events, incorporate advertising as an additional revenue source. Advertisements may appear in areas surrounding a playing field, such as on banners and billboard advertisements, or may be placed on participants' uniforms or vehicles. For example, one or more logos, decals, and other stickers may be placed on the side of an automobile in a car race, with the logos visible to viewers.

These advertisements are typically static, particularly in places where it may be difficult to change the advertisement mid-event, such as the side of a vehicle. In some instances, dynamic advertisements such as rotating or advancing displays or digital screens may be used, but these may be expensive, and may be advanced asynchronously with a camera view during a broadcast. For example, a digital display behind home plate during a baseball game may show a first advertisement during the pitch. The broadcast may change to a different camera to show the path of the ball or play in the field, during which time other advertisements may be shown on the display, unseen by the viewers. Advertisers whose ads are consequently not seen may be unhappy.

Additionally, with advances in networking and mobile computing, global positioning system (GPS) and other positioning systems, and graphics rendering technologies, it is possible to identify positions of sport or event participants within an environment, and provide this information to spectators. For example, GPS receivers may be integrated into race cars, with identified positions of the cars transmitted to devices of spectators, who may view the race via two-dimensional or three-dimensional representations. However, such representations frequently lack advertising, hampering a vital revenue source for the event operator and reducing the desire to focus development on virtualization technologies. Even if advertising is included, the advertising may be simply static representations of similarly static real-world advertisements around the event.

### SUMMARY OF THE INVENTION

The present application is directed to systems and methods for providing virtualized advertising in a simulated view of a real event. Event participants may have GPS receivers and data collection modules installed in vehicles, such as cars for vehicle racing events, boats for sailing races, planes for air races or acrobatic shows, or similar entities, or within equipment, such as helmets, padding, packs, or similar gear, as well as transmitters capable of sending the GPS data and collected data to local receivers for collation and processing. The data may be provided to a virtualization engine, which may generate a virtual environment modeled on the real world environment in which the event occurs. Virtual advertisement placement locations may be identified in the virtual environment as corresponding to a physical location in the real environment, such as a billboard, raceway signage, sky writing, vehicle livery advertisements, or other such locations. The virtualization engine may use the received data to generate virtual objects representing each event participant and/or their vehicle, and may place the virtual objects within the virtual environment at locations determined by positioning data. The virtualization engine may further generate one or more viewpoints or virtual cameras, and may place the cameras anywhere within the virtual environment, including within the virtual objects. The virtualization engine may then render, in real time or near real time, a realistic view of the virtual environment and virtual objects. The rendered view may thus comprise a realistic simulated view of the physical event. Unlike physical cameras, however, the rendered view may be arbitrarily positioned, including above participants, below participants, inside participants or their vehicles, in the middle of a track or path of participants, or anywhere else. Additionally, the virtual cameras may be moved or rotated during the event, and the rendered simulation may be paused, rewound, or slowed. The virtualization engine may also render a selected advertisement in the virtual advertisement placement location. Advertisements may be dynamically changed, may be animated or moving, or otherwise may be modified based on a user profile or motion of the virtual camera within the virtual environment.

Accordingly, virtual advertisements may be displayed to users within a simulated view of a real event. The virtual advertisements may be dynamically modified to replace physical advertisements, such as billboards or vehicle livery, allowing the same advertisement position to be sold to multiple advertisers. Advertisements may be modified based on the user's view or information about the virtual camera, such as lower resolution or larger print advertisements being displayed when the camera is moving quickly and finer details would likely not be perceived by the user. Similarly, more detailed advertisements may be displayed during slow motion or replays. Additionally, advertisements may be selected and displayed responsive to events that are likely to be replayed, such as exciting plays or vehicle crashes, potentially at a higher cost to advertisers.

In one aspect, the present disclosure is directed to a method for providing virtualized advertising in a simulated view of a real event. The method includes retrieving, by a virtualization engine executed by a processor of a computing device, mapping information for (i) a virtual environment corresponding to a real environment, and (ii) a virtual advertisement placement location corresponding to a physical location in the real environment. The method also includes receiving, by the virtualization engine, position and orientation data for a virtual camera generated on behalf of a user. The method further includes determining, by the virtualization engine, that a view of the virtual environment corresponding to the real environment according to the position and orientation data of the virtual camera includes the virtual advertisement placement location. The method also includes selecting an advertisement from an advertisement database. The method further includes rendering, by the virtualization engine according to the position and orientation data of the virtual camera, an image of the virtual environment corresponding to the real environment, and rendering, by the virtualization engine according to the position and orientation data of the virtual camera, an image of the selected advertisement according to the mapping information of the virtual advertisement placement location corresponding to the physical location.

In some embodiments, the method includes receiving position data from one or more additional computing devices within the real environment; and for each of the one or more additional computing devices, rendering a virtual object within the virtual environment at a position corresponding to the received position data for the corresponding computing device within the real environment, according to the mapping information.

In one embodiment of the method, the virtual advertisement placement location corresponds to a physical billboard. In another embodiment of the method, the virtual advertisement placement location corresponds to a location on a vehicle. In some embodiments, selecting an advertisement further includes retrieving a profile of the user comprising one or more interests of the user; and selecting an advertisement corresponding to said one or more interests. In other embodiments, selecting an advertisement further includes receiving angular velocity or linear velocity data for the virtual camera; determining that the angular velocity or linear velocity exceeds a threshold; and selecting an advertisement responsive to the determination. In still other embodiments, selecting an advertisement further includes identifying the occurrence of a predetermined event; and selecting a predetermined advertisement responsive to the identification. In yet still other embodiments, selecting an advertisement further includes receiving, by the virtualization engine, the selection of the advertisement from a second computing device.

In some embodiments, the method includes selecting a second advertisement from the advertisement database, responsive to expiration of an advertising time period; and rendering, by the virtualization engine according to the position and orientation data of the virtual camera, an image of the selected second advertisement according to the mapping information of the virtual advertisement placement location corresponding to the physical location. In other embodiments, the method includes incrementing a timer, by the virtualization engine, while the image of the selected advertisement is visible to the virtual camera.

In yet another aspect, the present disclosure is directed to a system for providing virtualized advertising in a simulated view of a real event. The system includes a computing device comprising a processor executing a virtualization engine. The virtualization engine is configured for retrieving mapping information for (i) a virtual environment corresponding to a real environment, and (ii) a virtual advertisement placement location corresponding to a physical location in the real environment. The virtualization engine is also configured for receiving position and orientation data for a virtual camera generated on behalf of a user. The virtualization engine is also configured for determining that a view of the virtual environment corresponding to the real environment according to the position and orientation data of the virtual camera includes the virtual advertisement placement location. The virtualization engine is also configured for rendering, according to the position and orientation data of the virtual camera, an image of the virtual environment corresponding to the real environment, and rendering, according to the position and orientation data of the virtual camera, an image of an advertisement selected from an advertisement database, according to the mapping information of the virtual advertisement placement location corresponding to the physical location.

In some embodiments of the system, the virtualization engine is further configured for receiving position data from one or more additional computing devices within the real environment; and for each of the one or more additional computing devices, rendering a virtual object within the virtual environment at a position corresponding to the received position data for the corresponding computing device within the real environment, according to the mapping information.

In one embodiment of the system, the virtual advertisement placement location corresponds to a physical billboard. In another embodiment of the system, the virtual advertisement placement location corresponds to a location on a vehicle. In some embodiments of the system, the virtualization engine is further configured for retrieving a profile of the user comprising one or more interests of the user; and the advertisement is selected to correspond to said one or more interests.

In other embodiments of the system, the virtualization engine is further configured for receiving angular velocity or linear velocity data for the virtual camera; determining that the angular velocity or linear velocity exceeds a threshold; and the advertisement is selected responsive to the determination. In still other embodiments of the system, the virtualization engine is further configured for identifying the occurrence of a predetermined event; and a predetermined advertisement is selected responsive to the identification.

In one embodiment of the system, the virtualization engine is further configured for receiving the selection of the advertisement from a second computing device. In another embodiment of the system, the virtualization engine is further configured for rendering, according to the position and orientation data of the virtual camera, an image of a second advertisement according to the mapping information of the virtual advertisement placement location corresponding to the physical location, the second advertisement selected responsive to expiration of an advertising time period. In still another embodiment, the virtualization engine is further configured for incrementing a timer while the image of the selected advertisement is visible to the virtual camera.

The details of various embodiments of the invention are set forth in the accompanying drawings and the description below.

### BRIEF DESCRIPTION OF THE FIGURES

The foregoing and other objects, aspects, features, and advantages of the invention will become more apparent and better understood by referring to the following description taken in conjunction with the accompanying drawings, in which:

FIG. 1A is a block diagram illustrative of an embodiment of a networked environment useful for the systems and methods described in this document;

FIG. 1B is a block diagram illustrative of a certain embodiment of a computing machine for practicing the methods and systems described herein;

FIG. 2A is a block diagram of an embodiment of a system for virtualization of a physical event;

FIG. 2B is another block diagram of an embodiment of a virtualization system;

FIG. 3A is a block diagram of an embodiment of a data capture and transmission system;

FIG. 3B is a block diagram of an embodiment of a virtualization system;

FIGS. 4A and 4B are illustrates of example embodiments of placement of advertisements in a real environment;

FIG. 5 is a flow chart of an embodiment of a method for providing virtualized advertising in a virtual environment simulating a real environment; and

FIGS. 6A-6F are screenshots of example embodiments of a virtual environment with virtual advertising.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

Prior to discussing methods and systems for generating a virtualized representation of a physical event, it may be helpful to discuss embodiments of computing systems useful for practicing these methods and systems. Referring first to FIG. 1A, illustrated is one embodiment of a networked environment 101 in which a simulated environment can be provided. As shown in FIG. 1A, the networked environment 101 includes one or more client machines 102A-102N (generally referred to herein as “client machine(s) 102” or “client(s) 102”) in communication with one or more servers 106A-106N (generally referred to herein as “server machine(s) 106” or “server(s) 106”) over a network 104. The client machine(s) 102 can, in some embodiments, be referred to as a single client machine 102 or a single group of client machines 102, while server(s) 106 may be referred to as a single server 106 or a single group of servers 106. Although four client machines 102 and four server machines 106 are depicted in FIG. 1A, any number of clients 102 may be in communication with any number of servers 106. In one embodiment a single client machine 102 communicates with more than one server 106, while in another embodiment a single server 106 communicates with more than one client machine 102. In yet another embodiment, a single client machine 102 communicates with a single server 106. Further, although a single network 104 is shown connecting client machines 102 to server machines 106, it should be understood that multiple, separate networks may connect a subset of client machines 102 to a subset of server machines 106.

In one embodiment, the computing environment 101 can include an appliance (not shown in FIG. 1A) installed between the server(s) 106 and client machine(s) 102. This appliance can mange client/server connections, and in some cases can load balance connections made by client machines 102 to server machines 106. Suitable appliances are manufactured by any one of the following companies: the Citrix Systems Inc. Application Networking Group; Silver Peak Systems, Inc, both of Santa Clara, Calif.; Riverbed Technology, Inc. of San Francisco, Calif.; F5 Networks, Inc. of Seattle, Wash.; or Juniper Networks, Inc. of Sunnyvale, Calif.

Clients 102 and server 106 may be provided as a computing device 100, a specific embodiment of which is illustrated in FIG. 1B. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and a client agent 120. The I/O controller 123, in some embodiments, is further connected one or more input devices. As shown in FIG. 1B, the I/O controller 123 is connected to a camera 125, a keyboard 126, a pointing device 127, and a microphone 129.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1B illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include a graphics processor or a graphics processing unit (not shown). The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

Embodiments of the computing device 100 include any one of the following I/O devices 130A-130N: a camera 125, keyboard 126; a pointing device 127; a microphone 129; mice; trackpads; an optical pen; trackballs; microphones; drawing tablets; video displays; speakers; inkjet printers; laser printers; and dye-sublimation printers; touch screen; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can execute any operating system, while in other embodiments the computing machine 100 can execute any of the following operating systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS VISTA; and WINDOWS 7; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein.

In other embodiments the computing machine 100 can be a mobile device such as any one of the following mobile devices: a JAVA-enabled cellular telephone or personal digital assistant (PDA), such as the i55sr, i58sr, i85s, i88s, i90c, i95c1, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; or any other handheld mobile device. In yet still other embodiments, the computing device 100 may a smart phone or tablet computer, including products such as the iPhone or iPad manufactured by Apple, Inc. of Cupertino, Calif.; the BlackBerry devices manufactured by Research in Motion, Ltd. of Waterloo, Ontario, Canada; Windows Mobile devices manufactured by Microsoft Corp., of Redmond, Wash.; the Xoom manufactured by Motorola, Inc. of Libertyville, Ill.; devices capable of running the Android platform provided by Google, Inc. of Mountain View, Calif.; or any other type and form of portable computing device.

In still other embodiments, the computing device 100 can be a virtual machine. The virtual machine can be any virtual machine managed by a hypervisor developed by XenSolutions, Citrix Systems, IBM, VMware, or any other hypervisor. In still other embodiments, the virtual machine can be managed by a hypervisor executing on a server 106 or a hypervisor executing on a client 102.

In still other embodiments, the computing device 100 can in some embodiments execute, operate or otherwise provide an application that can be any one of the following: software; an application or program; executable instructions; a virtual machine; a hypervisor; a web browser; a web-based client; a client-server application; an ActiveX control; a Java applet; software related to voice over internet protocol (VoIP) communications like a soft IP telephone; an application for streaming video and/or audio or receiving and playing streamed video and/or audio; an application for facilitating real-time-data communications; a HTTP client; a FTP client; or any other set of executable instructions. Still other embodiments include a client device 102 that displays application output generated by an application remotely executing on a server 106 or other remotely located machine. In these embodiments, the client device 102 can display the application output in an application window, a browser, or other output window.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices.

The computing environment 101 can include more than one server 106A-106N such that the servers 106A-106N are logically grouped together into a server farm 106. The server farm 106 can include servers 106 that are geographically dispersed and logically grouped together in a server farm 106, servers 106 that are located proximate to each other and logically grouped together in a server farm 106, or several virtual servers executing on physical servers. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

Referring now to FIG. 2A, illustrated is an abstraction of an embodiment of a system for virtualization of a physical event. In brief overview, a physical event 180, such as a race, athletic event, or other event, includes one or more objects 181, such as a race car, boat, airplane, human, bulldozer, police car, etc. that interact with the surrounding environment and with each other. The system receives position data 128 for each of the objects 181. The system generates a virtual environment 184 with virtual objects 185 representing each object 181, at a location determined by received position data 128. The system also identifies a position and direction for a virtual camera 186. In some embodiments, the system also identifies a zoom and/or focus for the virtual camera 186. Thus, the system may identify any parameter for the camera, including white balance, filters, color temperature, bit depth, resolution, or any such parameters. Similarly, determining the position may include identifying an acceleration, a velocity, a vibration frequency or amplitude, or any other such displacement.

Utilizing the virtual objects 185, attributes of the virtual environment 184, and the position, direction, and view attributes of the virtual camera 186, such as focus, resolution, speed, etc., the system renders a graphical view from the virtual camera 186 of a virtual event 187, corresponding to the physical event 180. By constantly updating the position data 182 and corresponding locations and directions of virtual objects 185, the rendered view from virtual camera 186 may comprise an accurate real-time representation of a view of the physical event from a real-world position corresponding to the position and direction of the virtual camera 186.

In some embodiments, the rendered view may be provided as part of a media broadcast. For example, a broadcast of a race may use the virtualized event to show a viewpoint from a virtual camera where no physical camera has been placed, or even could be placed. The virtual camera may be placed on the roadway, in a position locked to a vehicle such as a spoiler or bumper, in a chase or overhead view, or in any other position. In one embodiment, the virtual camera may be placed within a virtual vehicle, showing a simulation of what the driver sees. Because the view is virtualized, in some embodiments, the driver's hand motions may not be rendered. However, views through windshields may be appropriately rendered, providing a realistic simulated view. In a further embodiment, the virtual camera view from inside a vehicle may be used to recreate the driver's view during an accident or spin-out, even though no actual camera existed inside the vehicle.

In other embodiments, such as where the event is a boat race, the virtual camera may be placed on the water's surface, on a mast of a ship, on a virtual chase plane or boat following a virtual ship object, or even in locations previously unfilmable, such as underwater. In one such embodiment, the water may be rendered substantially more transparent than the real water, allowing an underwater virtual camera to view the positions of ships from distances much greater than would be possible in reality.

In still other embodiments, the event may comprise a military action, real or simulated for training purposes. In such cases, vehicles and troops may carry GPS transmitters, and the virtualization system may generate a virtual representation of the event, allowing a commander to move a virtual camera around the battlefield to see which areas are hidden from view, potential sniper or ambush locations, etc. In such cases, the lack of data from an opposing force is not a detriment, as the virtual camera may be used to locate areas that should be investigated by troops.

The rendered view may be provided to one or more client devices, including televisions, computers, tablet computers such as iPads, smart phones, or other devices. In some embodiments, due to the fact that rendered view is a virtual representation, the resolution of the rendered environment may be drastically reduced, allowing real time transfer over very low bandwidth connections or connections with bandwidth below a predetermined threshold, or to devices with reduced processing capability below a predetermined threshold. For example, a high resolution virtual rendered view may be provided to a device capable of receiving and displaying high-definition video. Conversely, a very low resolution rendered view, a non-textured view, a wireframe view, or other simple virtualizations may be provided to devices capable of receiving and displaying only low resolution video. In a further embodiment, static images may be delivered to devices, if necessary, or if useful for display purposes. For example, commentators on a media broadcast of an event may use a static rendered image from a particular viewpoint to display and discuss an interaction, such as a close call between two vehicles. The viewpoint may be selected to show the lateral displacement of the vehicle bumpers, for example.

In many embodiments, the virtual environment may be pre-rendered, reducing processing load on the virtualization system. For example, in embodiments with races, the track may be mapped and rendered in advance. In one embodiment, satellite map data, such as that provided via Google Maps by Google, Inc. of Mountain View, Calif., may be used to generate the topology and texture of the virtual environment. In other embodiments, the virtual environment may be generic, such as where the event is a water race or an airplane acrobatic show, and the virtual environment need simply be an expanse of open water or sky.

In a further embodiment, such as where participants in the event are in a relatively small region, GPS receivers and radio transmitters may not be needed. Instead, a physical camera may be used to capture real-time images of the event, and an image recognition system may be used to detect participants and locate them within the environment. For example, if the event is an ice hockey game, a camera may be used to record images of the game and an image recognition system may detect the locations of different players based on the colors of their uniforms. The players may then be rendered at the detected locations in a virtual environment, allowing a virtual camera to be positioned anywhere on the ice.

Referring now to FIG. 2B, illustrated is a diagram of an embodiment of a virtualization system 200 for an auto racing example. The system 200 includes car equipment 212 (e.g., a GPS receiver) positioned on the real-world car (i.e., dynamic or real object). For example, the GPS receiver 212 receives signals from multiple GPS satellites 205 and formulates a position of the car periodically throughout a race event 210. The car may be configured with other equipment 212 as shown, such as an inertial measurement unit (IMU), telemetry, a mobile radio, and/or other types of communication (e.g., WiMAX, CDMA, etc.). In some embodiments, a base station or communication solution 214 is also provided locally forming a radio communication link with the car's mobile radio. The base station 214 receives information from the car and relays it to a networked server 216. The server 216 can communicate the information from the car to a database 232 via the network 220. Although shown with specific connections, in many embodiments, components of virtualization system 200 may be interconnected or interact in other configurations.

The radio transmitter sends position information and any other telemetry data that may be gathered from the dynamic object to the radio base station 214. Preferably, the position information is updated rapidly, such as a rate of at least 30 Hz. In some embodiments, other event information 218, such as weather, flags, etc., may also be transmitted to the network server 216 from an event information system (not shown).

In some embodiments, radio messages for each of the different dynamic vehicles are preferably discernable from each other and may be separated in time or frequency. The communication between the car and the base station 214 is not limited to radio communication but may be any other type of communication, such as Wifi, WiMAX, 802.11, infrared light, laser, etc.

In some embodiments, an event toolset 234 processes the database 232 to normalize data and/or to identify event scenarios. In one embodiment, web services 236 provide a web interface for searching and/or analyzing the database 232. In some embodiments, one or more media casters 238 process the database 232 to provide real-time or near real-time data streams for the real-world events to a client device 250. In some embodiments, media casters 238 may comprise virtualization and rendering engines, while in other embodiments, virtualization and rendering engines may be part of a server 216 or web server 236.

Although FIG. 2B refers to auto racing, the technology is applicable to virtually any event in which a real world event (e.g., a sport, a game, derby cars, a boat race, a horse race, a motorcycle race, a bike race, a travel simulation, a military action, etc.) may be virtualized and a rendered virtual view from the position of a virtual camera may be displayed.

Referring now to FIG. 3A, illustrated is a block diagram of an embodiment of a system for data collection and transmission 300. In brief overview, the data collection system 300 may comprise a GPS antenna 301 and GPS unit 302. The data collection system 300 may also comprise a programmable control unit or processor 303. In some embodiments, the data collection system 300 may also include an inertial measurement unit 304, and/or one or more input/output units 305a-305n. In another embodiment, the data collection system 300 may include a radio modem and radio antenna 307. In many embodiments, the data collection system 300 may include a storage device 308. Data collection system 300 may further include a power supply unit 309, or connect to a power supply unit 309 of a vehicle.

Still referring to FIG. 3A and in more detail, in some embodiments, a data collection and transmission system 300 may comprise a GPS antenna 301 and GPS unit 302. GPS receivers are generally available and are used, for example, for navigation on board of the ships, to assist surveying operations, etc. GPS is based on an older system named Navstar (NAVigation by Satellite Timing And Ranging). The GPS system is operated by U.S. military authorities. Similar satellite navigations systems may be used, such as the Galileo system being developed by the European Union, the GLONASS system developed by Russia, the IRNSS system developed by India, the Beidou system developed by or the COMPASS system under development by the People's Republic of China, the QZSS system developed by Japan. In some embodiments, for improved accuracy, differential GPS receivers (DGPS) may be used. Differential GPS utilizes a local reference with an accurately known location. By applying a correction on the GPS data based on the local reference, the general accuracy can be improved significantly. For example, positional accuracy on a decimeter or centimeter level of granularity can be achieved. GPS receiver unit 302 may comprise any type or form of GPS receiver, such as any of the models of OEMV receivers manufactured by NovAtel of Canada, the Condor family of GPS modules manufactured by Trimble Navigation, Ltd. of Sunnyvale, Calif., or any other GPS receiver. GPS antenna 301 may comprise any type of single or dual frequency GPS antenna, such as a NovAtel GPS-702L antenna, or any other type and form of antenna.

In other embodiments, instead of a GPS antenna 301 and GPS unit 302, different position detection means may be employed. For example, laser measurements, short-range radio transponders placed in the raceway, or other position detection methods may be employed. As discussed above, in one such embodiment, a camera and image recognition algorithm may be used to visually detect the position of one or more dynamic objects.

In some embodiments, a data collection and transmission system 300 may comprise a processor or programmable control unit 303. Programmable control unit (PCU) 303 may comprise a programmable computer capable of receiving, processing, and transforming digital and analog sensor data, and transmitting the data as a serial data stream to a radio modem 306. The PCU 303 may comprise any type and form of programmable computer, and may comprise any of the types of computing device discussed above in connection with FIG. 1B. The PCU 303 may capture and transform sensor and GPS data into a serial data stream. In some embodiments, the PCU may include a timer and may provide a timestamp for values of the data stream.

In some embodiments, a data collection and transmission system 300 may comprise an inertial measurement unit 304. In one embodiment, an inertial measurement unit 304 may comprise a gyroscopic-based attitude and heading reference system (AHRS) for providing drift-free 3D orientation and calibrated 3D acceleration, 3D rate of turn (rate gyro) and 3D earth-magnetic field data. Inertial measurement unit 304 may comprise an MTI IMU from XSens Motion Technology of the Netherlands, any of the models of iSensor IMUs from Analog Devices Inc. of Norwood, Mass., or any other type and form of inertial measurement unit. IMU 304 may be mounted in the center of the object, or in any other location. Embodiments utilizing the latter may require recalibration of sensor data.

In some embodiments, a data collection and transmission system 300 may comprise one or more input/output units 305a-305n, referred to generally as I/O unit(s) 305. In some embodiments, an I/O unit 305 may comprise a sensor, such as a temperature sensor; fuel sensor; throttle position sensor; steering wheel, joystick or rudder position sensor; aerilon position sensor; tachometer; radio signal strength sensor; odometer or speedometer sensor; transmission position sensor, or any other type and form of sensor. In other embodiments, an I/O unit 305 may comprise a switch, such as a brake light switch, headlight switch, or other switch, or receive a signal from or detect position of such a switch. In still other embodiments, an I/O unit 305 may comprise a microphone or video camera. In yet still other embodiments, an I/O unit 305 may further comprise an output interface, such as a display, light, speaker, or other interface for providing a signal to an operator of a dynamic object, such as a driver of a race car. The output may include an indicator that the PCU 303 is receiving signal from a GPS unit or is broadcasting properly, for example. In some embodiments, I/O units 305 may be connected to or comprise sensors or other devices within a controller area network (CAN) or vehicle data bus.

In some embodiments, a data collection and transmission system 300 may comprise a radio modem 306 and radio antenna 307. Radio modem 306 and radio antenna 307 may provide communication with a ground station or receiver, and may transmit serial data provided by PCU 303. In one embodiment, radio modem 306 may comprise an E-ARF35 radio modem manufactured by Adeunis RF of France. Radio modem 306 may be single- or multi-channel, and may have any RF power level, including 250 mW, 500 mW, 1 W or any other value.

In many embodiments, a data collection and transmission system 300 may comprise a storage device 308, such as flash memory, for storing and buffering data, storing sensor calibration values, or storing translation or calculation programs of PCU 303. Any type and form of storage device 308 may be utilized.

In some embodiments, data collection and transmission system 300 may further comprise a power supply unit 309. For example, in embodiments in which data collection and transmission system 300 is carried by a person, power supply unit 309 may comprise a battery pack, solar panel, or other power supply. In other embodiments, such as where data collection and transmission system 300 is installed on a vehicle, the data collection system 300 may connect to the vehicle's engine or battery.

Data collection and transmission system 300 may be small and lightweight to meet requirements for auto racing or motorcycle racing, or to provide functionality without unduly burdening a human or animal carrying the system. For example, data collection and transmission systems 300 may be sufficiently small to be used by marathon runners, cyclists, camel or horse racers, players in a team sport, or in other such activities. The size of the data collection and transmission system 300 may be reduced in various embodiments by removing unneeded components, such as an interface for a CAN bus when the system is to be used in a race without such a network, such as a motorcycle race. The system may be less than 500 g in some embodiments, and may have dimensions of roughly 100 mm by 90 mm by 30 mm (±10%), or approximately 300 cubic centimeters in volume, such that the system may be easily installed in a vehicle without compromising performance, or may be carried by a person or animal. In other embodiments where space and weight are not at a premium, additional components and/or sensors may be included. For example, the system may be less than 250 g, less than 150 g, or may less than 750 g, less than 1 kg or any other such range. Similarly, the system may be less than 300 cubic centimeters in volume, such as 250 cubic centimeters, 200 cubic centimeters, or any such volume, or may be more than this volume, such as 350 cubic centimeters, 400 cubic centimeters, or any other such volume, and the length, depth, and width of the system may vary accordingly, as well as with respect to each other such that the aspect ratio is different than mentioned above.

Referring now to FIG. 3B, illustrated is a block diagram of an embodiment of a virtualization engine or virtualization server 330. In brief overview, virtualization server 330 may comprise a network interface 331 for receiving data from data collection and transmission system(s) 300 and providing rendered images or video to client devices; a real-data location module 332 for interpreting and/or collating received data and mapping location data of real objects into a virtual environment 334; a rendering engine 336 for rendering views of virtual objects in the virtual environment; a processor 338; a storage device 339; a physics engine 340; a user profile database 342; and an advertising database 344. Processor 338, storage device 339 and network interface 331 may comprise any type or form of processor, storage devices, and network interfaces discussed above in connection with FIG. 1B. In some embodiments, the virtualization server or virtualization engine may be executed on one or more central servers, with image and/or video data transmitted or streamed to one or more client devices. This may allow client devices with limited processing or memory capabilities to still utilize a fully rendered virtual environment. In other embodiments, data may be transmitted to the client devices and rendered locally, taking advantage of capabilities of the client device. Accordingly, virtualization engine 330 may be in a single device or spread across multiple devices. For example, in one such embodiment, an advertising database 344 may be maintained on central server or server farm, and selected advertisements may be transmitted to a client device for rendering via a rendering engine 336 of the client device in a virtual environment 334 presented on the client device.

Still referring to FIG. 3B and in more detail, a real-data location module 332 may comprise an application, service, daemon, server, or other executable code for determining a virtual location of a real-data object in the virtual environment 334 based on a real location of the real-data object in the real environment, and responsive to received sensor data such as GPS or IMU sensors. In one embodiment, real-data location module 332 may comprise functionality for receiving multiple sets of location or position information from multiple objects in the real environment, such as multiple race cars, and translating the information into virtual code objects for placement within a virtual environment 334. Virtual code objects may comprise data sets of object identifiers, position data, velocity and direction data, heading data, etc., and real-data location module 332 may collate the data and generate a record with the object identifier for processing by the rendering engine 336.

Virtual environment 334 may comprise a simulated virtual environment based on a real environment, such as a race track, expanse of ocean or sky, ground terrain, city environment, outer space or orbit environment, or other real environment. In some embodiments, virtual environment 334 may comprise terrain and texture maps, and textures applied to the maps. Many tools exist for creating virtual environments, such as 3D studio Max, Blender, AutoCAD, Lightwave, Maya, Softimage XSI, Grome, or any other type of 3D editing software. In some examples, a representation of the local environment for the event includes position information of static objects (i.e., track). For example, the position information includes latitude, longitude, and elevation of points along the race track. Such points can be obtained from a topographical map, such as Google Earth, and/or any other map source.

Rendering engine 336 may comprise an application, service, daemon, server, routine, or other executable code for rendering a 3D or 2D image from one or more virtual camera viewpoints within a virtual environment 334. In some embodiments, rendering engine 336 may utilize ray tracing, ray casting, scanline rendering, z-buffering, or any other rendering techniques, and may generate wireframe, polygon, or textured images. In many embodiments, rendering engine 336 may render the view of a virtual camera in real-time. In some embodiments, such as for use with 3D televisions, rendering engine 336 may render stereoscopic views from two displaced virtual cameras. Virtual cameras may be placed arbitrarily throughout the virtual environment, including inside virtual objects, and may have static positions or may travel through the environment, for example, following or positioned relative to a particular object. Similarly, virtual cameras may rotate to follow an virtual object. For example, a virtual camera may have a fixed position at a turn, for example, and may rotate to track or follow a virtual car navigating the turn. Accordingly, a virtual camera may have a rotational velocity and/or a linear velocity. Values of these may be used in selecting advertisements, discussed in more detail below.

In some examples, rendering engine 336 may render environmental data in the virtual environment, based on real-world data of the environment, including realistic time-of-day lighting, weather, flags or signs, wave height, clouds, or other data. As discussed above, in some embodiments, rendering engine 336 may generate low-resolution rendered images or video, for display by client devices with reduced processing power or slower network connectivity.

In some embodiments, rendered images or video may be provided to a media server or HTTP server for streaming or pseudo-streaming to one or more client devices. Multiple media servers or casters may be located in a geographically dispersed arrangement (e.g. worldwide) to provide low-latency connections to client devices. In one embodiment, rendering and/or streaming may be offloaded to a server farm or rendering or streaming engine operated via a cloud service.

In some embodiments, users may view rendered images or video through a media playback system, such as a television, computer media player application, web page, or other interface. In other embodiments, users may view rendered images or video through an interactive application. The application may provide capability for the user to specify a virtual camera position within the virtual environment or otherwise move or rotate the virtual camera, or select from a plurality of currently-rendered virtual cameras. The application may transmit a request to the virtualization system to generate a virtual camera at the specified location and generate a new rendered image or video.

In some embodiments, the application may allow interaction with images or 3D data of the virtual environment, such as measuring displacement between two virtual objects; pausing, playing back, rewinding, or fast-forwarding video or playing video in slow-motion; zooming in on a part of an image; labeling an image or virtual object; or any other interaction.

In some embodiments, different data collection and transmission systems 300 and/or different communications networks may be used to provide flexibility and reliability, particularly in events that occur across a wider geographic area. For example, many rally races include circuits covering over 50 kilometers. High-bandwidth radio coverage of the entire course may be expensive and impractical. Accordingly, a hybrid system may be implemented to provide reduced data via a wide area communication system, such as satellite phones or cellular modems, and increased or high resolution data at one or more positions along the course via a radio network. Thus, in regions with radio coverage, high resolution data may be obtained from a data capture and transmission system via short or medium range radio, and in regions without radio coverage, lower resolution data may be obtained via cellular or other networks.

The virtualization engine 330 may include a physics engine 340. Physics engine 340 may comprise an application, routine, service, daemon, or other executable logic for simulating physical systems, including collision detection and rigid body dynamics. The physics engine may be used for realistic interpolation of intermittent position data of objects or other such features.

The virtualization engine 330 may include a user profile database 342. In some embodiment, a user profile database 342 may comprise a database, flat file, data array, or other data file including information about one or more users, including local or remote users. Information in a user profile may be entered by the user when signing up or registering with the server; may be populated via retrieval from one or more social networking services such as Facebook, LinkedIn, or Twitter; and/or may be added over time as the user utilizes the virtualization system. The information may include an identification of preferences of the user, either explicitly identified by the user (e.g. genres of movies or television shows that the user likes, product categories the user is interested in, etc.) and/or implicitly identified by the user selecting displayed advertisements or by parsing social media profiles, postings, or other data for keywords indicating user preferences. For example, if a user has sent a social network message indicating attendance at a particular concert, this may be parsed and an identifier of a music genre, band or artist may be added to the user's profile. Similarly, if the user has selected an advertisement for a luxury watch in the past, an identification of a corresponding class of goods (e.g. luxury accessories) or the manufacturer may be added to the user's profile.

The virtualization engine 330 may also include an advertising database 344. Advertising database may comprise a directory, database, data array, or other type and form of file or files of print, image, or multimedia advertisements. Each advertisement may comprise an image, video, audio, text, or any other type and form of advertisement. In some embodiments, an advertisement may have multiple versions, including a low resolution or simple version and a high resolution or complex version. Although sometimes referred to as low resolution and high resolution, in many embodiments, the advertisements may be different. For example, a “low resolution” advertisement may include just the advertiser's logo, while a “high resolution” advertisement may include one or more product pictures, text, or other information. In one embodiment, selection of a simple or complex version of an advertisement may be performed responsive to how far away the virtual advertisement is placed from the virtual camera. For example, in one such embodiment, if the virtual advertisement placement location is less than a predetermined distance from the virtual camera, a complex advertisement may be selected. If the virtual camera is farther away, a simpler advertisement may be selected for display. Similarly, in some embodiments, advertisements may be selected based on a linear and/or rotational velocity of the virtual camera. For example, if a virtual camera is following a virtual race car at high speed down a track, a user may be unable to read complex advertisements on stationary billboards or signage within the view. Accordingly, if the linear velocity of the virtual camera exceeds a predetermined threshold, a simple advertisement or advertisements may be selected for placement on the stationary billboards or signage that may be more readily perceived by the user. Similarly, if the rotational velocity of the virtual camera exceeds a threshold, simpler advertisements may be selected for display.

In one embodiment, an advertisement may be dynamically replaced with a more complex version during slow motion views, still images, or replays of an event, as these may allow the user to perceive more complexity in the advertisement. In some embodiments, an advertiser may be charged more for display of complex advertisements, or may contract to have simple and complex advertisements displayed for a predetermined amount of time. For example, given a corrected advertisement display time x; a time tₛ during which a simple advertisement is displayed; a coefficient kₛ corresponding to the simple advertisement; a time t_{c} during which a complex advertisement is displayed; and a coefficient k_{c} corresponding to the simple advertisement, an advertiser may contract for an amount a to have their advertisements displayed for time x with x=tₛ*kₛ+t_{c}*k_{c}. One of skill in the art may readily appreciate that additional levels of advertisements and corresponding coefficients kₙ may be included. Each client device may include or maintain a timer for timing the values of t_{(s, c . . . n)} and may transmit these values to a central advertising server for billing the advertiser or providing auditing of displayed advertisements. In some embodiments, to ensure that the corrected time x meets or exceeds a contract value, additional short advertisements may be displayed when the user switches views or selects a new virtual camera. For example, if a race is nearing completion, and a user has viewed a particular advertisement only 80% of the time that the advertiser contracted for, the advertisement may be briefly displayed before the user may view a leaderboard.

Although referred to as a simple and complex advertisement, these terms are used as relative identifiers, rather than descriptions of the simplicity or complexity of the advertisement. Furthermore, in many embodiments, multiple levels of complexity may be used and selected according to multiple thresholds. Although referred to as versions of an advertisement, in many embodiments, the simple and complex advertisements may be related only to the same advertiser, rather than by being two versions of the same advertisement.

In some embodiments, an advertisement may be selected responsive to an event occurrence, such as a dramatic play, a scoring opportunity, or a vehicle crash. Such events may be replayed by the user, providing additional opportunities to view an advertisement, and in some embodiments, may also be submitted as a user-submitted video to a video hosting service such as YouTube. Thus, the selected advertisement may be viewed repeatedly and therefore have a higher value to advertisers. Accordingly, in some embodiments, an advertiser may enter into a contract to purchase an advertisement placement in a visible position responsive to the occurrence of an event. Such contracts may be at a premium price and may be in connection with another contract or separate. This may allow for greater advertiser flexibility. For example, one advertiser may prefer to pay a first price for virtual advertising that is constantly visible on billboards and signage within the virtual environment, while another advertiser may prefer to pay a second price for advertising that is only selected upon the occurrence of an event and only at a location in proximity to the event. In one embodiment, placement of advertisements during events may be via an auction pricing system, such that advertisers can bid for the opportunity to have their advertisement visible in the background of slow-motion replays and uploaded videos.

Referring briefly to FIGS. 4A and 4B, shown are illustrations of physical locations in a real environment 400 which may be used for mapping information for virtual advertisement placement locations in a virtual environment. As shown in FIG. 4A, a real environment 400 such as a race track may include one more billboards 404a-404c, frequently positioned at locations where physical cameras 406a-406b may be pointed, such as curves, straight-aways, finish lines, etc. Similarly, as shown in FIG. 4B, other advertising locations may include track-side signage 408a-408n, as well as one or more logos 412 on vehicle livery 410. Other advertising locations in real environments 400 may include digital billboards or displays, banners, field-side signage or displays, scoreboards or leader boards, racing boat sails, airplane livery, sky writing or towed banners, or other such locations.

The physical locations of real world advertisements 404, 408, 412 may be identified in mapping information for the virtual environment. Such mapping information may include boundary coordinates in three dimensions, including coordinates on a virtual object for logos within vehicle livery. The mapping information may define a plane or surface upon which an advertisement is displayed. In some embodiments, the mapping information may define a three-dimensional and/or textured space or section of a mesh or bump map of the virtual environment.

Virtual advertisements may be placed according to the mapping information by modifying a surface texture or bitmap image applied to a surface of the virtual environment, or by overlaying a second texture upon the virtual environment at the identified coordinates. In one embodiment, all of the virtual advertisements for the virtual environment may be selected simultaneously and placed at corresponding locations within a single bitmap or texture with transparent regions at every location where the real environment does not have a physical environment. The advertisement texture may then be laid over the environmental texture to display the advertisements and the real environment, visible through the transparent regions. In a similar embodiment, the texture or bitmap of the virtual environment may have transparent regions corresponding to the physical advertisements, and a second texture or bitmap may be placed behind the environmental texture and visible through the transparent regions. Accordingly, one or more textures may be applied to display advertisements.

In one embodiment, mapping information for an advertisement may be dynamically varied, such that the virtual advertisement placement location may be modified. For example, in one such embodiment, the location may be translated at the same velocity as the virtual camera, allowing the advertisement to stay in the same position within the rendered image and “slide” along the virtual environment, such as track-side signage that stays stationary within the view as a virtual camera chases a car. In other embodiments, the size or orientation of a virtual placement location may be varied, allowing a virtual advertisement to always be the same size and oriented upright regardless of position of the virtual camera relative to the virtual advertisement. In a similar embodiment, the size of an advertisement may be dynamically increased or decreased, allowing display of large logos on vehicle livery, for example, or increasing the size of advertisements if the virtual camera moves past them at high speed, allowing higher legibility.

Referring now to FIG. 5, illustrated is a flow chart of an embodiment of a method for providing virtual advertising in a virtual environment corresponding to a real environment. At step 500, a virtualization engine executed by a device may retrieve mapping information for a virtual environment corresponding to a real environment. The real environment may comprise a playing field, race track, sailing or boat track, aerial race track, or any other type and form of real environment. Mapping information for the virtual environment may comprise a two-dimensional or three-dimensional map or mesh of polygons representing a surface of the real environment. The mapping information may be retrieved from a second computing device, such as a server, or may be stored in a storage device maintained by the computing device executing the virtualization engine.

At step 502, the virtualization engine may retrieve mapping information of one or more virtual advertisement placement locations. These virtual advertisement placement locations may correspond to a physical advertisement in the real environment, and may be defined by coordinates, surfaces, polygons, or other entities. Physical advertisements may include billboards; banners; digital or moving displays; track-side or field-side advertisements; painted logos; vehicle livery or logos on said livery; sky writing or towed banners; or any other type and form of advertisement.

At step 504, the virtualization engine may receive virtual camera information from a user. The virtual camera information may comprise a selection by the user of a predetermined virtual camera location or position, including a fixed position corresponding to a physical camera, a chase view behind a virtual object representing a real object such as a vehicle or participant, or a view inside a vehicle or from a participant's perspective. Such selections may have a corresponding predetermined position or orientation, such as a position corresponding to a physical camera or a position relative to a virtual object. In other embodiments, the user may select a custom position and/or orientation within the virtual environment, allowing free positioning of the virtual camera within the environment. In some embodiments, and particularly with chase cameras or cameras selected to track a specific virtual object, the camera may have a linear and/or rotational velocity such that successive images rendered from the perspective of the virtual camera represent movement of the camera through space.

At step 506, in some embodiments, the virtualization engine may determine if a virtual advertisement placement location is visible to the virtual camera, according to the position and orientation information for the virtual camera. An advertisement may be considered visible if, in some embodiments, a surface of the virtual advertisement placement location is not obscured or is not obscured beyond a predetermined threshold percentage, is within a predetermined distance to the virtual camera, and/or is oriented towards the virtual camera. This may be done to prevent the need to select advertisements for non-visible advertisement placement locations. However, in other embodiments, step 506 may be skipped, and advertisements may be selected for all placement locations. For example, in many embodiments, the same advertisement may be selected for all placement locations, and thus it may be more efficient to simply select once.

At step 508, an advertisement may be selected. In some embodiments, the virtualization engine on the client device may select an advertisement, while in other embodiments, an advertising server on another device may select an advertisement and transmit the advertisement or the selection of the advertisement to the virtualization engine on the client. In many embodiments, as discussed above, the advertisement may be selected based on a contract with an advertiser, such as a contract to show an advertisement or set of advertisements for a period of time or a corrected advertisement display time, based on coefficients proportional to the complexity of an advertisement. In a further embodiment, an advertisement may be selected responsive to an end time for the event approaching with a percentage of the contract with the advertiser left unfulfilled. In a still further embodiment, such advertisements may be displayed as brief intermediate pages prior to display of a leaderboard or other information. In some embodiments, the advertisement may be selected from a subset of advertisements based on a user profile, which may include social networking information, past purchase or advertisement selection information, explicit identification of preferred advertisements or product or service categories, or other such information. In some embodiments, the advertisement may be selected based on a linear velocity and/or rotational velocity of the virtual camera exceeding a threshold. The linear velocity of the virtual camera may be measured relative to the virtual advertisement placement location, if the advertisement is also moving (e.g. on the livery of a vehicle).

At step 510, the virtualization engine may render the virtual environment from the perspective of the virtual camera. Rendering the virtual environment may comprise performing a ray tracing routine or other rendering process. In some embodiments, rendering the virtual environment may comprise rendering one or more virtual objects corresponding to physical objects in the real environment, such as vehicles. Accordingly, in such embodiments, a tracking system may receive tracking data from a device, such as a data acquisition and transmission module or mobile device installed in a vehicle or carried by a participant. The data may be received via a high-bandwidth but limited-range radio network, or via cellular or satellite modem. In some embodiments of the latter, the data may be limited and not include inertial measurements or control states, or may be sent at low temporal resolution, such as providing position data every 10 seconds or every minute, rather than multiple times per second.

If the data is low accuracy or limited data, then in some embodiments, the tracking system may identify position information for the vehicle or participant. In some embodiments, the tracking system may identify heading or direction information, or may interpolate such heading or direction information based on previous measurements. For example, the tracking system may identify a current position for a vehicle, a previous position for a vehicle, and extend a vector between the positions to identify a likely present heading. Similarly, the tracking system may identify a speed for the vehicle or participant based on distance travelled between successive measurements.

The tracking system may update position information within a database and/or on a map for the vehicle or participant. Position information may be two dimensional or three dimensional, based on capabilities of the mobile device, and the data may be updated accordingly. The tracking system may compile position information for the vehicle or participant with position information of other vehicles or participants and may provide or display position information of a plurality of participants or vehicles to telemetry viewers of client devices.

In some embodiments, the data may be of high accuracy or resolution, the tracking system may identify position, direction, speed, and/or any other data, including control states or positions, throttle or gear information, or other details. As discussed above, a database and/or map may be updated with the information, previously interpolated values may be updated with measured values, and/or the data may be compiled with data of other vehicles or participants.

At step 512, the virtualization engine may render the selected advertisement in the virtual advertisement placement location in accordance with position and orientation information of the virtual camera. In some embodiments, the virtualization engine may layer a texture, bitmap, or other visual data of the advertisement on a texture, bitmap, or other visual data of the virtual environment, while in other embodiments, the virtualization engine may layer the virtual environment on the advertisement or an advertisement layer. As discussed above, transparent regions may be used in either case to allow the background layer to be seen. In still other embodiments, steps 512 and 510 may be performed together, by placing the selected advertisement in a texture or bitmap for the virtual environment and then rendering the environment in a single pass.

Referring now to FIGS. 6A-6F, illustrated are screenshots of example embodiments of a virtual environment 600 with virtual advertising. The virtual advertising is shown in virtual advertising placement locations corresponding to physical locations in a real environment corresponding to the virtual environment 600. Referring first to FIG. 6A, as shown, a virtual environment 600 may comprise a view from a virtual camera (not shown) of the environment and one or more virtual objects 185a-185b. The view may also include virtual advertising such as billboards 404a-404c and signage 408a-408b. As shown in FIG. 6B, the selected advertisement may be dynamically changed to display billboards 404a′-404c′ and signage 408a′-408b′. Although all of the advertisements are identical in the example shown, in many embodiments, they may be different. Similar to FIGS. 6A-6B, FIGS. 6C-6D illustrate another embodiment of dynamic replacement of advertising. As shown, signage 408c-408e in FIG. 6C may be replaced with signage 408c′-408e′ in FIG. 6D. As shown in FIGS. 6E and 6F, the virtual environment 600 is not limited to land.

Advertisements such as billboard 404d in FIG. 6E may be dynamically replaced as shown in billboard 404d′ in FIG. 6F. As shown, in many embodiments, rendering the virtual environment and/or advertising may include rendering reflections of the advertising on portions of the virtual environment 600.

In addition to dynamic replacement and display of virtualized advertising to users in real-time, the above systems and methods may be used to identify physical locations for advertising or for marketing purposes. For example, the virtualization engine may monitor what parts of the virtual environment are in view the longest, across multiple users. The operator of the venue or event may utilize this information to determine where to place physical advertising in the future such that it will be most visible to local spectators or broadcast viewers. Similarly, because virtualized events may be replayed, the operator of the venue may use the virtualization system to show potential advertisers what a broadcast of a past event would have looked like, had they purchased a particular advertising location.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are exemplary and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed:

1. A method for providing virtualized advertising in a simulated view of a real event, comprising:
retrieving, by a virtualization engine executed by a processor of a computing device, mapping information for (i) a virtual environment corresponding to a real environment, and (ii) a virtual advertisement placement location corresponding to a physical location in the real environment;
receiving, by the virtualization engine, position and orientation data for a virtual camera generated on behalf of a user;
determining, by the virtualization engine, that a view of the virtual environment corresponding to the real environment according to the position and orientation data of the virtual camera includes the virtual advertisement placement location;
selecting an advertisement from an advertisement database;
rendering, by the virtualization engine according to the position and orientation data of the virtual camera, an image of the virtual environment corresponding to the real environment; and
rendering, by the virtualization engine according to the position and orientation data of the virtual camera, an image of the selected advertisement according to the mapping information of the virtual advertisement placement location corresponding to the physical location.

2. The method of claim 1, further comprising:
receiving position data from one or more additional computing devices within the real environment; and
for each of the one or more additional computing devices, rendering a virtual object within the virtual environment at a position corresponding to the received position data for the corresponding computing device within the real environment, according to the mapping information.

3. The method of claim 1, wherein the virtual advertisement placement location corresponds to a physical billboard.

4. The method of claim 1, wherein the virtual advertisement placement location corresponds to a location on a vehicle.

5. The method of claim 1, wherein selecting an advertisement further comprises retrieving a profile of the user comprising one or more interests of the user; and selecting an advertisement corresponding to said one or more interests.

6. The method of claim 1, wherein selecting an advertisement further comprises receiving angular velocity or linear velocity data for the virtual camera; determining that the angular velocity or linear velocity exceeds a threshold; and selecting an advertisement responsive to the determination.

7. The method of claim 1, wherein selecting an advertisement further comprises identifying the occurrence of a predetermined event; and selecting a predetermined advertisement responsive to the identification.

8. The method of claim 1, wherein selecting an advertisement further comprises receiving, by the virtualization engine, the selection of the advertisement from a second computing device.

9. The method of claim 1, further comprising:
selecting a second advertisement from the advertisement database, responsive to expiration of an advertising time period; and
rendering, by the virtualization engine according to the position and orientation data of the virtual camera, an image of the selected second advertisement according to the mapping information of the virtual advertisement placement location corresponding to the physical location.

10. The method of claim 1, further comprising:
incrementing a timer, by the virtualization engine, while the image of the selected advertisement is visible to the virtual camera.

11. A system for providing virtualized advertising in a simulated view of a real event, comprising:
a computing device comprising a processor executing a virtualization engine, the virtualization engine configured for:
retrieving mapping information for (i) a virtual environment corresponding to a real environment, and (ii) a virtual advertisement placement location corresponding to a physical location in the real environment,
receiving position and orientation data for a virtual camera generated on behalf of a user,
determining that a view of the virtual environment corresponding to the real environment according to the position and orientation data of the virtual camera includes the virtual advertisement placement location,
rendering, according to the position and orientation data of the virtual camera, an image of the virtual environment corresponding to the real environment, and
rendering, according to the position and orientation data of the virtual camera, an image of an advertisement selected from an advertisement database, according to the mapping information of the virtual advertisement placement location corresponding to the physical location.

12. The system of claim 11, wherein the virtualization engine is further configured for:
receiving position data from one or more additional computing devices within the real environment; and
for each of the one or more additional computing devices, rendering a virtual object within the virtual environment at a position corresponding to the received position data for the corresponding computing device within the real environment, according to the mapping information.

13. The system of claim 11, wherein the virtual advertisement placement location corresponds to a physical billboard.

14. The system of claim 11, wherein the virtual advertisement placement location corresponds to a location on a vehicle.

15. The system of claim 11, wherein the virtualization engine is further configured for retrieving a profile of the user comprising one or more interests of the user; and wherein the advertisement is selected to correspond to said one or more interests.

16. The system of claim 11, wherein the virtualization engine is further configured for receiving angular velocity or linear velocity data for the virtual camera; determining that the angular velocity or linear velocity exceeds a threshold; and wherein the advertisement is selected responsive to the determination.

17. The system of claim 11, wherein the virtualization engine is further configured for identifying the occurrence of a predetermined event; and wherein a predetermined advertisement is selected responsive to the identification.

18. The system of claim 11, wherein the virtualization engine is further configured for receiving the selection of the advertisement from a second computing device.

19. The system of claim 11, wherein the virtualization engine is further configured for rendering, according to the position and orientation data of the virtual camera, an image of a second advertisement according to the mapping information of the virtual advertisement placement location corresponding to the physical location, the second advertisement selected responsive to expiration of an advertising time period.

20. The system of claim 11, wherein the virtualization engine is further configured for incrementing a timer while the image of the selected advertisement is visible to the virtual camera.
